(19) United States
(12) Patent Application Publication
(10) Pub. No.: US 2006/0120828 A1
(43) Pub. Date: Jun. 8, 2006

(54) Book binding kit

(76) Inventor: Hirotaka Kato, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/234,229

(22) Filed: Sep. 26, 2005

(30) Foreign Application Priority Data
Dec. 2, 2004 (JP) 2004-349747

(51) Int. Cl. B42B 9/00

(52) U.S. Cl. 412/20

(57) ABSTRACT

To provide a book binding kit easy for a user to fabricate an original book, it includes one set composed of a paper having a printing surface and an adhesive surface to which a release paper having a cut line to form a cover member is attached, a front cover paperboard to be attached to a front cover region of the adhesive surface, a backbone paperboard to be attached to a backbone region of the adhesive surface, a back cover paperboard to be attached to a back cover region of the adhesive surface, and a body of pages made of a plurality of sheets bound together at one end. The release paper is divided into a front cover release paper, a front cover groove release paper, a backbone release paper, a back cover groove release paper, a back cover release paper, and a flap release paper.

### BACKGROUND OF THE INVENTION

1. Field of the Invention

The present invention relates to a book binding kit, and more particularly, to a book binding kit to be assembled by a user oneself for fabricating a book or a booklet.

2. Related Art

As conventional book binding kits, there is known one disclosed in JP-A-2003-170675. This book binding kit comprises a cover member including a front cover and a back cover, which are provided on both sides of a backbone, a plurality of book pages stacked between the front cover and the back cover, a front flap member arranged between the book pages and the front cover, a back flap member arranged between the book pages and the back cover, and rivets to bind the front and back flap members and the book pages, so that the members can be bound together into a book by a predetermined method.

Thus, a printer can print characters, photographs, pictures, patterns, etc., which are stored in a personal computer on the book pages. Accordingly, without the use of any special book binding implement, anyone can fabricate an original album, a picture book, a picture diary, etc.

However, while an original album or the like on which desired photographs etc. are printed, can be fabricated with such conventional book binding kits, there is not involved a process of creating a front cover, a back cover, a backbone, etc. by cutting, pasting and bending individual members. That is, the conventional book binding kit has a principal object in fabricating contents to be drawn on book pages, and is lacking in cutting and pasting operations needed to fabricate a book. Further, although contents for book pages can be freely fabricated, no consideration is given to draw a desired title and pictures on a front cover, a back cover, or a backbone.

### SUMMARY OF THE INVENTION

It is an object of the invention to solve the problems in conventional book binding kits and to provide a book binding kit capable of being constructed easily to increase fun in fabricating a book and drawing desired titles, photographs, etc. on the front cover, back cover, or backbone.

Hereupon, in order to attain the object, the invention provides a book binding kit comprises one set composed of a paper provided on one surface thereof with a printing surface on which can be represented information such as characters, photographs, pictures, or the like, and on the other surface thereof with an adhesive surface to which a release paper is attached, the release paper being provided with a cut line to form a cover member, a front cover paperboard to be attached to a front cover region of the adhesive surface, a backbone paperboard to be attached to a backbone region of the adhesive surface, a back cover paperboard to be attached to a back cover region of the adhesive surface, and a body of pages made of a plurality of sheets bound together at one end thereof, wherein the release paper attached to the adhesive surface is divided into a front cover release paper attached to the front cover region, a front cover groove release paper attached adjoining one edge of the front cover release paper, a backbone release paper adjoining one edge of the front cover groove release paper and attached to the backbone region, a back cover groove release paper attached adjoining one edge of the backbone release paper, a back cover release paper adjoining one edge of the back cover groove release paper and attached to the back cover region, a flap release paper attached over the area of a predetermined width along the cut line, and a margin release paper outside the cut line, and an adhesive paper, to which a page release paper is attached, is provided on the backbone, front and back sides of the body of pages.

Also, the printing surface may be provided with guide indicators indicating a proper position for printing. Further, the front cover release paper, the backbone release paper, and the back cover release paper may be colored. Furthermore, each of the sheets may have a printing surface enabling to represent information such as characters, photographs, pictures, or the like.

The book binding kit according to the invention has good workability compared with conventional ones, to increase fun in fabricating a book because a user oneself fabricates the book by cutting the paper along the cut line, attaching the front cover paperboard, the backbone paperboard, and the back cover paperboard to the adhesive surface of the paper, or bending the paper and attaching the body of pages to the cover member.

Further, since the paper has a printing surface enabling to represent information such as characters, photographs, pictures, etc., there are produced various excellent effects that desired titles, photographs, pictures, or the like can be drawn on a front cover, a back cover, or a backbone cover of a booklet.

Also, titles, photographs, pictures, or the like can be represented in proper positions on the front cover, back cover, or backbone cover by providing a guide indicator indicating a proper position for printing on the printing surface.

Further, by coloring the front cover release paper, the backbone release paper, the back cover release paper, the release papers can be visually and distinctly recognized to contrast a boundary with the unused periphery, which is convenient at the time of peeling-off.

Furthermore, the pages of the book can comprise a printing surface enabling to represent information such as characters, photographs, pictures, or the like, whereby contents being drawn on the -sheets can be freely fabricated, thus enabling the user to fabricate an original book.

### BRIEF DESCRIPTION OF THE DRAWING

FIG. 1 is a perspective view showing a set of book binding kit according to the invention;

FIG. 2 is a plan view showing a state, in which desired printing is performed on a printing surface of a paper;

FIG. 3 is a plan view showing a state, in which release papers are attached to an adhesive surface of the paper;

FIG. 4 is a perspective view showing the adhesive surface of the paper and the release papers in separate positions;

FIG. 5 is a perspective view showing a state, in which the paper is cut along a cut line and a margin is removed;

FIG. 6 is a perspective view showing a state, in which a front cover paperboard, a backbone paperboard, and a back cover paperboard are attached to respective adhesive surface portions in a front cover region, a backbone region, and a back cover region;

FIG. 7 is a perspective view showing a state, in which flap regions are folded at the upper and lower edges and the front cover paperboard, the backbone paperboard, and the back cover paperboard are attached to the paper;

FIG. 8 is a perspective view showing a state, in which the flap regions at left and right edges are folded and attached to the front cover paperboard and the back cover paperboard;

FIG. 9 is a perspective view showing a state, in which a body of pages is attached to a cover member; and

FIG. 10 is a perspective view showing a booklet.

### DETAILED DESCRIPTION OF PREFERRED EMBODIMENT

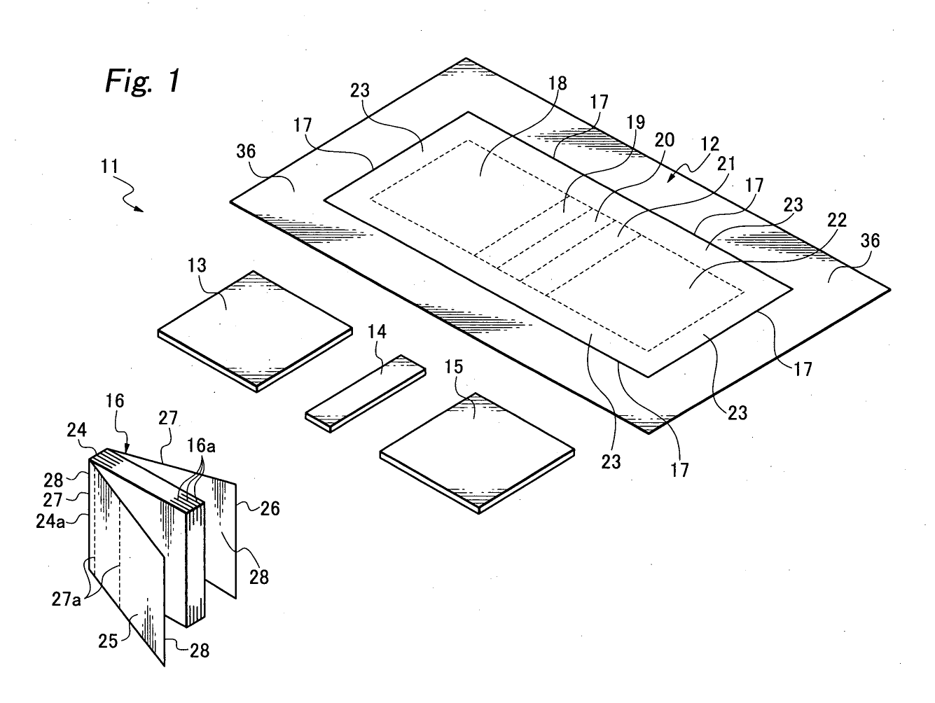

An embodiment of the invention will be described below with reference to the drawings. As shown in FIG. 1, a book binding kit 11 comprises a set composed of a paper 12, a front cover paperboard 13 to be attached to a front cover region 18a of the paper 12, a backbone paperboard 14 to be attached to a backbone region 20a of the paper 12, a back cover paperboard 15 to be attached to a back cover region 22a of the paper 12, and a body of pages 16 made of a plurality of sheets 16a, 16a, . . . , bound together at one end 24a thereof.

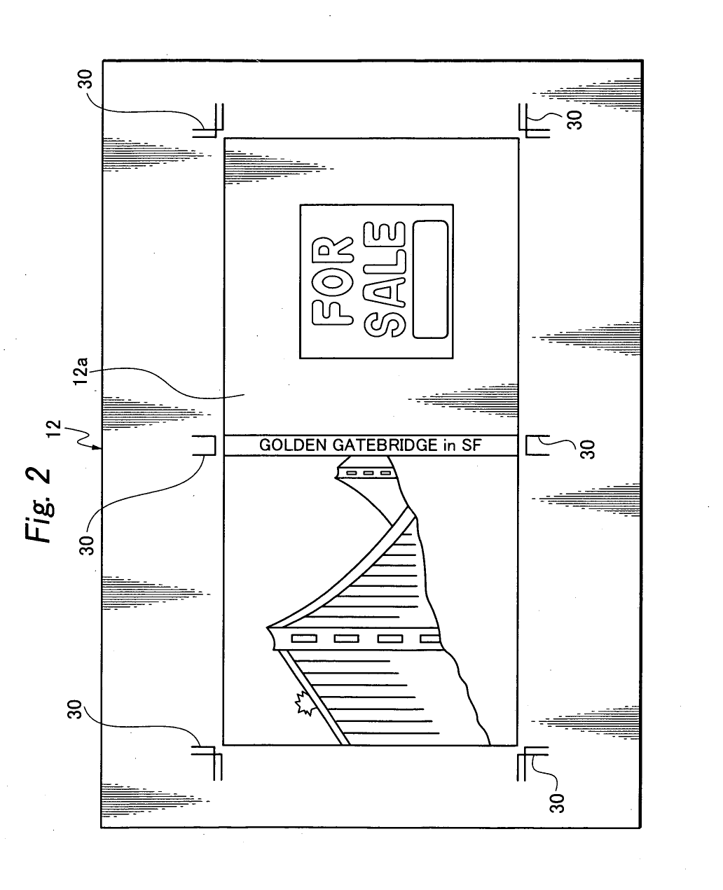

The paper 12 is of a predetermined size, such as A4, B4, etc. and used with the longer side extending laterally. One surface of the paper 12 provides a printing surface 12a, on which characters, photographs, pictures, or the like can be printed as shown in FIG. 2. The printing surface 12a is subjected to treatment corresponding to ink jet printing so as to enable printing by, for example, a printer of a personal computer. However, even in case of not being subjected to such treatment, it suffices in a word that characters, photographs, pictures, etc. can be printed on the printing surface 12a by a printer, or the like.

Guide indicators 30 for guiding of proper positions for printing are provided in predetermined locations on the printing surface 12a as shown in FIG. 2. Titles, photographs, pictures, etc. can be printed in proper positions on a front cover, a back cover, or a backbone paperboard by printing along the inside of the guide indicators 30.

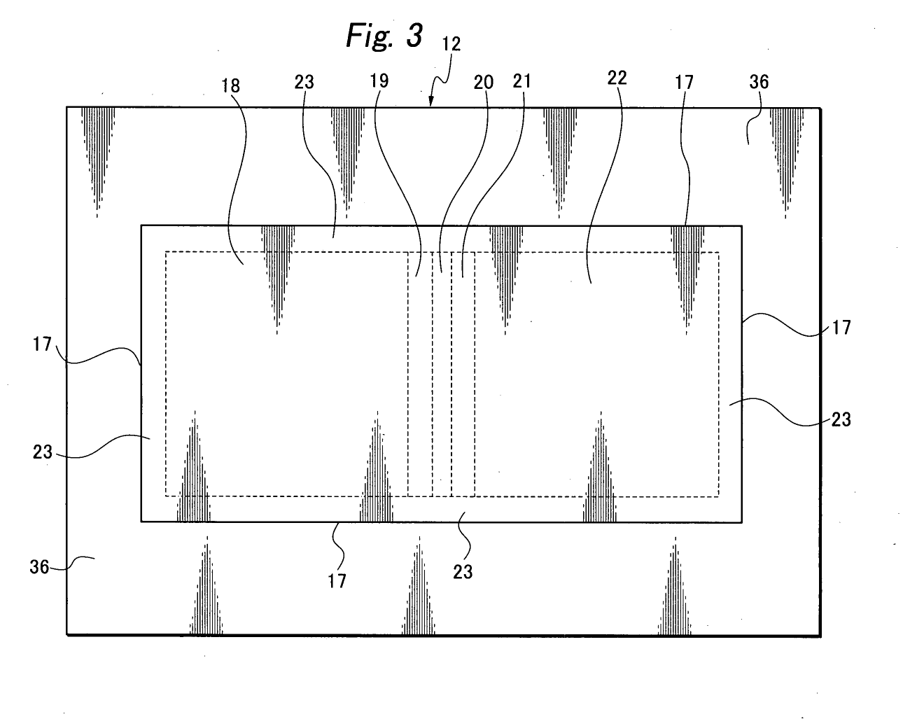

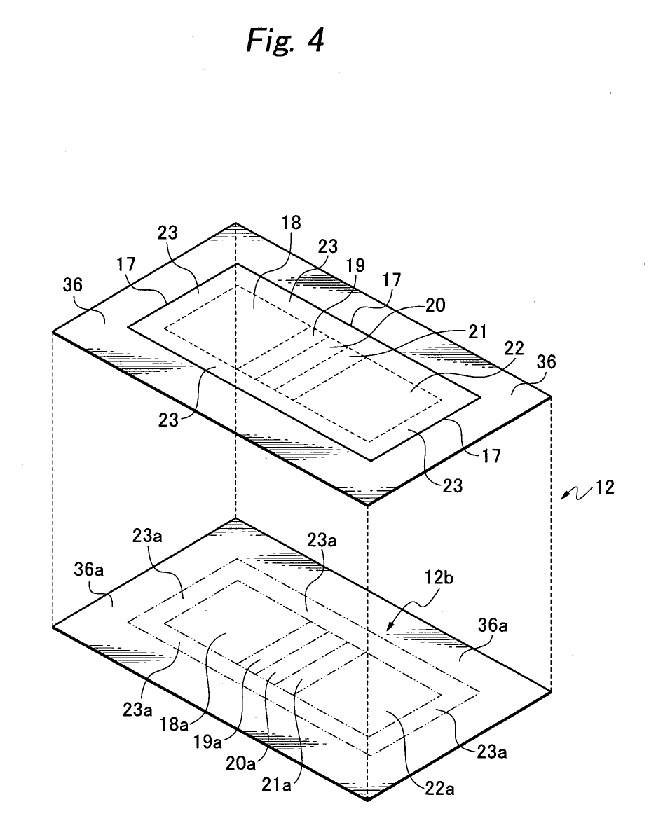

Also, the other surface of the paper 12 provides an adhesive surface 12b, to which a release paper is attached, as shown in FIGS. 3 and 4. The release paper is provided with a cut line 17 to form a cover member 31. The paper 12 is cut into a rectangular shape, which is longer sideways with regard to the book and has a predetermined size, by cutting along the cut line 17 with a scissors, a cutter, or the like.

The release paper attached to the adhesive surface 12b is divided, as shown in FIG. 4, into a front cover release paper 18 attached to a front cover region 18a, a front cover groove release paper 19 adjoining one edge of the front cover release paper 18 and attached to a front cover groove region 19a, a backbone release paper 20 adjoining one edge of the front cover groove release paper 19 and attached to a backbone region 20a, a back cover groove release paper 21 adjoining one edge of the backbone release paper 20 and attached to a back cover groove region 21a, a back cover release paper 22 adjoining one edge of the back cover groove release paper 21 and attached to a back cover region 22a, a flap release paper 23 disposed along the cut line 17 and attached to a flap region 23a having a predetermined width, and a margin release paper 36 attached to a margin 36a outside the cut line 17. The adhesive surface 12b of the paper 12 can be exposed by freely peeling off the respective release papers 18, 19, 20, 21, 22, 23 and 36.

Also, it is desirable that the front cover release paper 18, the backbone release paper 20, and the back cover release paper 22 be colored different from the remaining release papers. This makes peeling-off convenient since the release papers 18, 20, 22 can be visually contrast with the circumference and so the boundary between them can be distinctly recognized.

The front cover paperboard 13 has the same size as that of the front cover region 18a of the adhesive surface 12b, assumes a square shape or a rectangular shape, and is made of a paperboard material having a predetermined hardness.

The backbone paperboard 14 has the same size as that of the backbone region 20a of the adhesive surface 12b, assumes a narrow rectangular shape of predetermined width and length, and is made of a paperboard material having a predetermined hardness.

The back cover paperboard 15 has the same size as that of the back cover region 22a of the adhesive surface 12b, assumes a square shape or a rectangular shape, and is made of a paperboard material having a predetermined hardness. In addition, the back cover paperboard 15 is formed to have the same size as that of the front cover paperboard 13.

The body of pages 16 comprises a plurality of sheets 16a, 16a, . . . , which are formed to be square-shaped or rectangular-shaped and bound at an edge 24a thereof by bonding or the like. Also, an adhesive paper 28 is provided on the back portion 24, front side 25, and backbone side 26 of the body of pages 16, and a page release paper 27 is attached to a surface of the adhesive paper 28. The page release paper 27 is formed in appropriate positions thereof with cuts 27a so that an adhesive surface of the adhesive paper 28 can be exposed by peeling off the page release paper 27 one region at a time as necessary.

Also, each sheet 16a has a printing surface, on which characters, photographs, pictures, etc. can be printed. Like the printing surface of the paper 12, the printing surface enables printing characters, photographs, pictures, etc. by a printer, or the like.

Subsequently, an explanation will be given of an example of the procedure of the work of fabricating a book with the use of the book binding kit 11. First, desired characters, photographs, pictures, etc. are printed on the printing surface 12a of the paper 12, and desired titles, photographs, pictures, etc. are printed in positions corresponding to the front cover, the back cover, or the backbone paperboard. In this case, printing can be performed in proper positions corresponding to the front cover, the back cover, or the backbone paperboard by printing along the inside of the guide indicators 30 (see FIG. 2).

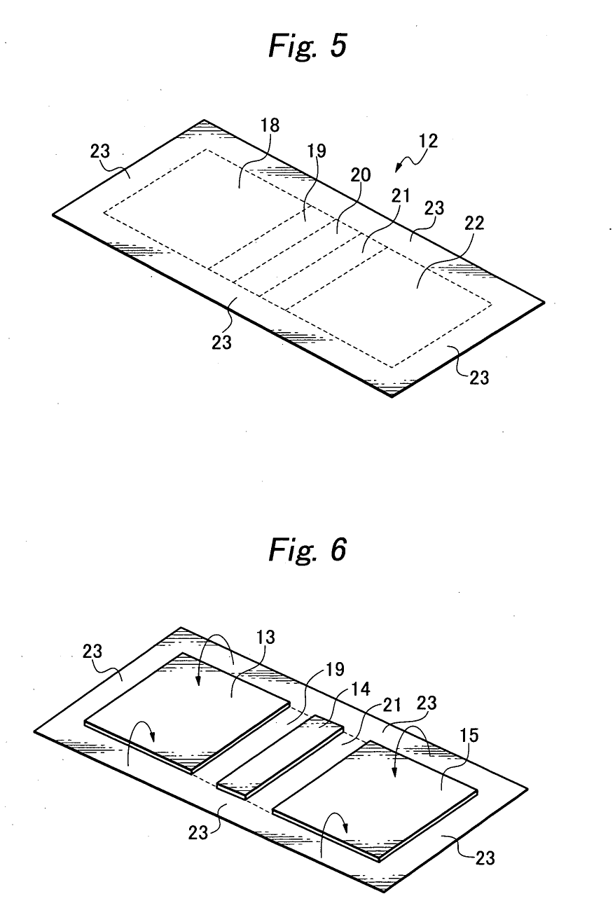

A scissors, or a cutter is used to perform cutting along the cut line 17 on the paper 12 to form the paper 12 into a rectangular shape of a predetermined size, and a margin 36a outside the cut line 17 is removed together with the margin release paper 36 (see FIGS. 4 and 5).

Subsequently, the front cover release paper 18, the backbone release paper 20, and the back cover release paper 22 on the paper 12 are peeled off respectively to expose the adhesive surface portions 12b in the front cover region 18a, the backbone region 20a, and the back cover region 22a. In this case, when the front cover release paper 18, the backbone release paper 20, and the back cover release paper 22 are colored different from the remaining release papers, peeling-off is facilitated since the above regions contrast well with the periphery.

The front cover paperboard 13, the backbone paperboard 14, and the back cover paperboard 15 are attached to the respective adhesive surface portions 12b exposed in the front cover region 18a, the backbone region 20a, and the back cover region 22a, respectively (see FIG. 6).

Then, the front cover groove release paper 19, the back cover groove release paper 21, and the flap release paper 23 on the paper 12 are peeled off to expose the adhesive surface portions 12b in the front cover groove region 19a, the back cover groove region 21a, and the flap region 23a.

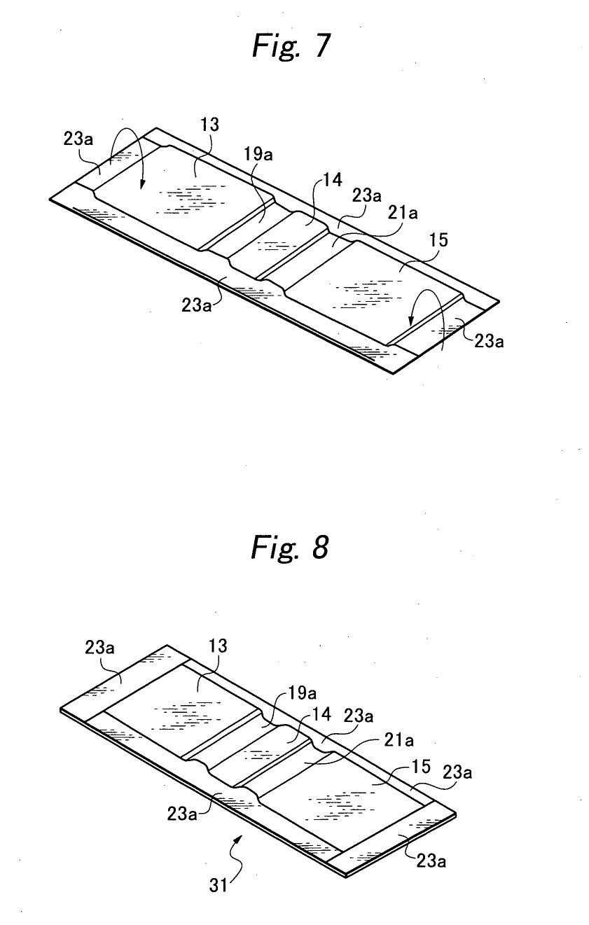

Subsequently, the flap region 23a at upper and lower edges are folded and attached to the front cover paperboard 13, the backbone paperboard 14, and the back cover paperboard 15 (see FIG. 7). Further, the flap region 23a at both left and right edges are folded and attached to the front cover paperboard 13 and the back cover paperboard 15. In this manner, the cover member 31 is formed (see FIG. 8).

On the other hand, desired characters, photographs, pictures, etc. may be printed on the sheets 16a of the body of pages 16 to freely create contents of the sheets 16a. Alternatively, instead of printing on the sheets 16a, writing may be freely done on the sheets 16a of the book after fabrication.

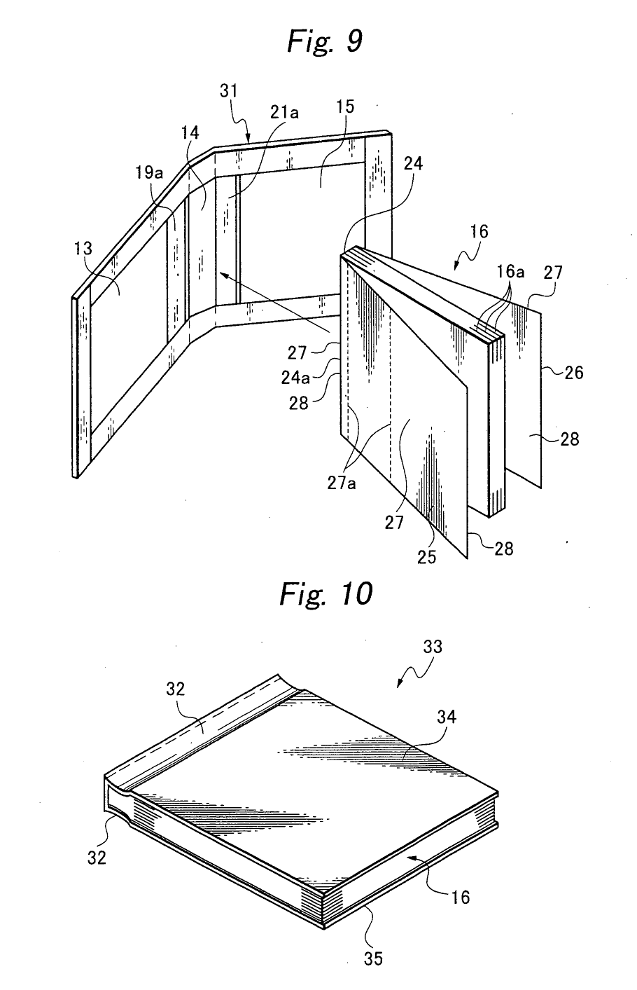

Subsequently, the page release paper 27 on the body of pages 16 is peeled off, and an adhesive surface of the back portion 24 is attached to the backbone paperboard 14 of the cover member 31. Then, the page release paper 27 on the front side 25 and the back side 26 of the body of pages 16 is peeled off to expose the adhesive surfaces there, which are attached to the adhesive surface portions 12b in the front cover groove region 19a and the back cover groove region 21a (see FIG. 9).

At this time, the back side surfaces of the front cover groove region 19a and the back cover groove region 21a are pushed by fingers to strongly stick to adhesive surfaces on the front side 25 and the back side 26 of the body of pages 16, forming these portions into inwardly concave grooved portions 32 (see FIG. 10).

Further, the adhesive surfaces on the front side 25 and the back side 26 of the body of pages 16 are attached to the front cover paperboard 13 and the back cover paperboard 15, respectively.

In this manner, by forming the grooved portions 32 on base sides of the front cover 34 and back cover 35 of a book 33 as shown in FIG. 10, it is possible to fabricate the book 33 in which the front cover 34 and the back cover 35 are easy to open and close and which is of high quality comparing favorably with books on the market.

The booklet 33 can be fabricated by the work described above. Accordingly an original book can be fabricated by a user oneself, fabricated by cutting and attaching respective members, so that the operations are easy to execute, increasing the fun in fabricating a book.

What is claimed is:

1. A book binding kit comprising one set composed of
a paper provided on one surface thereof with a printing surface on which can be represented information such as characters, photographs, pictures, or the like, and on the other surface thereof with an adhesive surface to which a release paper is attached, the release paper being provided with a cut line to form a cover member,
a front cover paperboard to be attached to a front cover region of the adhesive surface,
a backbone paperboard to be attached to a backbone region of the adhesive surface,
a back cover paperboard to be attached to a back cover region of the adhesive surface, and
a body of pages made of a plurality of sheets bound together at one end thereof,
wherein the release paper attached to the adhesive surface is divided into a front cover release paper attached to the front cover region, a front cover groove release paper attached adjoining one edge of the front cover release paper, a backbone release paper adjoining one edge of the front cover groove release paper and attached to the backbone region, a back cover groove release paper attached adjoining one edge of the backbone release paper, a back cover release paper adjoining one edge of the back cover groove release paper and attached to the back cover region, a flap release paper attached over the area of a predetermined width along the cut line, and a margin release paper outside the cut line, and
an adhesive paper, to which a page release paper is attached, is provided on the backbone, front and back sides of the body of pages.

2. A book binding kit according to claim 1, wherein the printing surface is provided with guide indicators indicating a proper position for printing.

3. A book binding kit according to claim 1, wherein the front cover release paper, the backbone release paper, and the back cover release paper are colored.

4. A book binding kit according to claim 1, wherein each of the sheets has a printing surface enabling to represent information such as characters, photographs, pictures, or the like.
